(19) United States
(12) Patent Application Publication
(10) Pub. No.: US 2022/0147867 A1
(43) Pub. Date: May 12, 2022

(54) VALIDATION OF GAMING SIMULATION FOR AI TRAINING BASED ON REAL WORLD ACTIVITIES

(71) Applicant: International Business Machines Corporation, Armonk, NY (US)

(72) Inventors: Sarbajit K. Rakshit, Kolkata (IN); Michael Bender, Rye Brook, NY (US); Craig M. Trim, Ventura, CA (US); Martin G. Keen, Cary, NC (US)

(21) Appl. No.: 17/096,567

(22) Filed: Nov. 12, 2020

(51) Int. Cl. G06N 20/00

(52) U.S. Cl. CPC G06N 20/00; A63F 13/803

(57) ABSTRACT

An approach for identifying training data to exclude from being sent to an AI system from a simulation based on the confidence level that the simulation produced accurate data is disclosed. The approach can generate simulation data to include conditions from historical data captured in the physical world and utilize responses from the physical world as a benchmark. The approach can compare similar simulation and benchmark responses to generate a confidence level for the simulation data and exclude data with low level of confidence from flowing to the AI system training.

### BACKGROUND

The present invention relates generally to artificial intelligence, and more particularly to training artificial intelligence with simulations.

In regards to machine learning, there is an understanding that data is needed in the construction of algorithms that can learn from and make predictions. In fact, a large amount of data is needed in the initial/current training set. The data used to build the initial and final model usually comes from multiple data sources. Datasets can be categorized into i) training data, ii) validation data and iii) test data.

A training dataset is a dataset of examples used during the learning process and is used to fit the various parameters (i.e., classifier). A validation dataset is a dataset of examples used to tune the hyper-parameters of a classifier. A test dataset is a dataset, typically is independent of the training dataset, but that tracks the same probability distribution as the training dataset. For example, if a model fit to the training dataset and it also fits the test dataset well, a minimal overfitting situation has occurred.

### SUMMARY

Aspects of the present invention disclose a computer-implemented method, a computer system and computer program product for select training data to be used as part of a training dataset for a machine learning system. The computer implemented method may be implemented by one or more computer processors and may include: XYZ.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a high level overview of the AI training environment, designated as 100, in accordance with an embodiment of the present invention;

FIG. 2 is a functional block diagram illustrating the subcomponents of AI training component 111, in accordance with an embodiment of the present invention;

FIG. 3A is a high-level flowchart illustrating the operation of AI training component 111, designated as 300A, in accordance with an embodiment of the present invention;

FIG. 3B is a flowchart illustrating an alternative operation of AI training component 111, designated as 300B, in accordance with another embodiment of the present invention; and

FIG. 4 depicts a block diagram, designated as 400, of components of a server computer capable of executing the AI training component 111 within the AI training environment 100, in accordance with an embodiment of the present invention.

### DETAILED DESCRIPTION

In the current state art associated with training a machine learning system, there is a large volume of data to sift through to determine which data is useful for training and can be labor intensive for a human operator. For example, building a machine learning computer vision system (i.e., teaching to drive a car) that is reliable enough to identify objects, such as traffic lights, stop signs, and pedestrians, requires thousands of hours of video recordings that consist of hundreds of millions of video frames. Each one of these frames needs all of the important elements like the road, other cars, and signage to be labeled by a human before any work can begin on the model to develop. The majority of models created today require a human to manually label data in a way that allows the model to learn how to make correct decisions.

Embodiments of the present invention provides an approach, by leveraging machine learning, for selecting reliable and consistent training dataset from a simulation, to be used to train an artificial intelligence (e.g., neural network, etc.) system. The training dataset can be used to teach a machine learning system on a variety of applications (e.g., self-driving vehicle, robots used in manufacturing, etc.). The approach utilizes a gaming simulation (e.g., virtual, augmented reality, etc.) created by the embodiment (based on the collected data of the user's activities from the physical world) for the same users to participate in order to create meaningful training dataset. Embodiment would rank the quality of the simulation (from the user) data based on comparing the simulation reactions against the tendencies of the same user exhibits in their daily life (i.e., data captured by IoT sensors). If there is a high correlation between controlled activities in the simulation and daily activities, then the confidence about the quality of the data used for additional scenarios (of that same user) is considered higher. Thus, those data from the additional scenarios and/or simulation (of the same user) can be used for training a machine learning system. However, if there is a low correlation, which would suggest that the data is not to be trusted or used in building a corpus, then the data is not selected. For example, the embodiment can provide an approach by collecting real world driving data from a user and creating a driving game simulation/simulator. The user would complete the driving game and data from the game is compared against the real world data of the same user. Embodiment would determine if the game data meets a confidence level of threshold. If the game data does meet the confidence level of threshold then the game data can be used to help with the computer vision system to label data in the video frame and/or other training related data (including future simulation/scenario data from the same user).

Other embodiments of the present invention may recognize one or more of the following facts, potential problems, potential scenarios, and/or potential areas for improvement with respect to the current state of the art: i) can eliminate unnecessary data when the system determines that the person generating the data is behaving in a manner that is inconsistent with the way that person would act in real life and ii) can eliminate the need for a human to manually label data for training an AI system.

Other embodiments of the present invention provides an approach for identifying training data to exclude from being sent to an AI system from a simulation based on the confidence level that the simulation produced accurate data. The approach can generate simulation data to include conditions from historical data captured in the physical world and utilize responses from the physical world as a benchmark. It is noted that the simulation data can be further enhanced by using samples of historical interactions. The approach can compare similar simulation and benchmark responses to generate a confidence level for the simulation data and exclude data with low level of confidence from flowing to the AI system training. It is noted that the comparison can include the use of temporal analysis of the different components of the simulation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

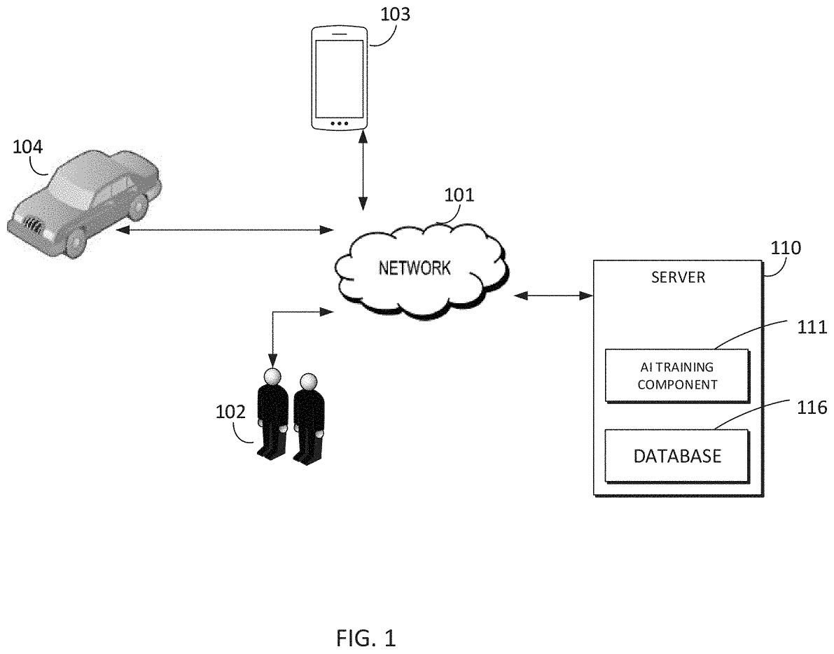

FIG. 1 is a functional block diagram illustrating an AI training environment 100 in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

AI training environment 100 includes network 101, users 102, sensors 103, simulation 104 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110, sensors 103 and other computing devices (not shown) within AI training environment 100. It is noted that other computing devices can include, but is not limited to, sensors 103, simulation 104 and any electromechanical devices capable of carrying out a series of computing instructions.

Users 102 can be any humans capable of carrying ordinary tasks such as, but it is not limited to, driving a car, operating machinery, performing daily tasks at work and/or home and performing recreational activities (e.g., golf, tennis, fishing, etc.).

Sensors 103 can be any smart device (e.g., IoT, IP camera, etc.) used for detecting objects, chemical compounds/elements, auditory signals, electromagnetic signal and images. Sensors 103 can include IoT devices, such as, cameras, olfactory, thermal sensors/imaging, microphones, interface to vehicles (i.e., OBDII) and machines, and chemical detectors. Sensors 103 can detect the routine and function of users 102. IoT devices track interactions of the person with the item (e.g. car) that is involved with the training. Additional sensors can used to track the surrounding environment and the response of the action (e.g. car turns) if appropriate. Environmental information (e.g. temperature, sunlight) can be captured from IoT devices or from secondary feeds. Biometric feeds can be enabled from IoT devices to track the users under different levels of stress. For example, a camera, hear rate monitor and OBDII sensor can capture and collect data related to a user's drive to work, grocery and other car related activities. Data collected by sensors 103 can be saved locally to a storage device and/or stream in real-time for storage by a database (e.g., cloud storage, database 116, etc.).

It is noted that different biometric readings impact the trust of the data from the simulation because the person's physical reactions are different in the simulation than in the physical world.

Simulation 104 can be any VR (virtual reality) and/or AR (augmented reality) system capable of creating simulations and able to collect data from users utilizing the simulations. Simulations can include, but it is not limited to, cars simulation, operating machinery simulation, performing daily tasks at work and/or home simulation and performing recreational activities (e.g., golf, tennis, fishing, etc.) simulations. Simulation 104 can include devices/sensors that can measure/record any feedback from the user while the user is using the simulation. For example, a scenario (requiring the use of a physical keyboard) is performed by the user in the simulation. Simulation 104 can measure and record all available data related to the keyboard, data such as, but it is not limited to, keyboard stroke strength, keyboard typing speed, rate of keystroke, etc.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 and digital twin server 105 can be a laptop computer, a tablet computer, a netbook computer, a personal computer (PC), a desktop computer, a personal digital assistant (PDA), a smart phone, or any other programmable electronic device capable of communicating other computing devices (not shown) within AI training environment 100 via network 101. In another embodiment, server 110 represents a computing system utilizing clustered computers and components (e.g., database server computers, application server computers, etc.) that act as a single pool of seamless resources when accessed within AI training environment 100.

Embodiment of the present invention can reside on server 110. Server 110 includes AI training component 111 and database 116.

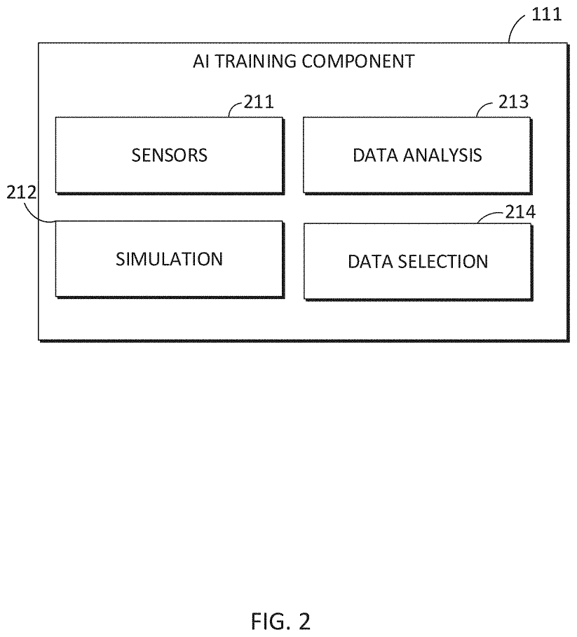

AI training component 111, leveraging machine learning, provides the capability of identify training data to exclude from being sent to an AI system from a simulation based on the confidence level that the simulation produced accurate data. For example, an individual person registers for participating in a gaming simulation to train an AI (artificial intelligence) system. The embodiment captures real world activities (via IoT or other sensors) related to the simulation based on different conditions. The embodiment builds a simulation that includes conditions that are needed to train the AI (i.e., conditions from the real world that the individual has experienced). The individual participates in the simulation and the system captures activities and responses. The embodiment compares the simulation to the reactions in the real world. The embodiment eliminates simulation data where the system has determined that the person is responding in a manner that is inconsistent with real responses. Subcomponents of AI training component 111 will be discussed in greater details associated with FIG. 2.

Database 116 is a repository for data used by AI training component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within AI training environment 100, provided that AI training component 111 has access to database 116. Database 116 may store information associated with, but is not limited to, knowledge corpus, i) statistical data analysis techniques, ii) techniques used to create simulations based on collected real world data, iii) historical data saved from real world observations of users, iv) AI training data and v) confidence level associated with users.

FIG. 2 is a functional block diagram illustrating AI training component 111 in accordance with an embodiment of the present invention. In the depicted embodiment, AI training component 111 includes sensors component 211, simulation component 212, data analysis component 213 and data selection component 214.

Functionality of AI training component 111 can be summarized with the following features: i) generate simulation data to include conditions from historical data captured in the physical world, ii) utilize responses (i.e. observations) from the physical world as a benchmark, iii) compare similar simulation and benchmark responses to generate a confidence level for the simulation data and iv) exclude or include data depending on the confidence level to/from an AI system training.

As is further described herein below, sensors component 211 of the present invention provides the capability of gathering historical (from databases) and real-time data from sensors 103 (and other sources) associated with users 102. The captured data from real world activities can be used a baseline to determine if simulation data should be included in training of the AI system. Initial setup can include sensors component 211 registering sensors 103 (i.e., IoT devices) with the system to be begin data collection. Once, sensors 103 has been registered with the system, it can begin to capture user's data. For example, user1 is driving a vehicle as part of his normal routine (e.g., driving to work, drive to the gym and drive to the grocery store, etc.). Sensors component 211 via sensors 103 (e.g., OBDII interface collect vehicle telemetry data, biometric sensor on a smartwatch and IoT camera captures surrounding car environment such as, traffic, pedestrians, etc.) located around the user1 can capture his driving habit.

As is further described herein below, simulation component 212 of the present invention provides the capability of generating situation/scenarios, via a simulation based on the collected data from sensors component 211. The generated simulations are used/stored in simulation 104. Data from sensors component 211 can be used to create scenarios in the simulation for the user. Some scenarios may need additional training information from a manual file while other scenarios can rely on collected data from sensors component 211 or a combination of both data sources. However, simulation component 212 filters the collected data before any simulations can be generated. Filtering by simulation component 212 involves categorizing the data to determine predictable responses to stimuli (i.e., collected from users). Any existing data classification techniques can be used for categorizing data such as, but it is not limited to, pattern recognition, regression, probabilistic classification and data parsing. Using the collected data, patterns can be determined based on the historically captured data. Once the data has been categorized/classified, a desired scenario (i.e. manually picked by the user or AI system) can be selected. Simulation component 212 can begin building a simulation based on the desired scenario. For example, referring to the previous example of user1, the data collected based on the driving habit of user is used to generate one or more driving simulations for user1. User1 can be asked to participate in the driving simulation (i.e., located in simulation 104) and the data can be collected on the performance of user1 from the simulation. One driving simulations can include scenarios related to highway driving. Another driving simulation can include scenarios related to parallel parking or parking in a narrow defined space (i.e., parking garage in a big city).

As is further described herein below, data analysis component 213 of the present invention provides the capability of comparing the data from the simulation against the collected historical data (i.e., real world response/activities of the user) and creating a confidence level score (i.e., 95% confidence) based on the compared data. Any existing statistical data analysis techniques can be used, to calculate confidence interval, such as, t-distribution normal distribution and z-distribution. Based on the confidence interval, a confidence level (e.g., 85%, 99%, etc.) can be derived. The system can be trained with outlier data as a basis to determine that level (i.e., purposefully act different in a simulation). Data confidence can also be different based on temporal information (e.g. user1 was driving in the simulation like he normally do for 30 minutes but then suddenly changed his norms). The temporal information can allow partial use of simulation data while confidence levels were high. It is noted that data analysis component 213 compares a user's data against himself (i.e., collected real world versus data from the simulation) and not against another user.

As is further described herein below, data selection component 214 of the present invention provides the capability of excluding data that has been determined not useful (i.e., low degree of confidence level) for AI training from data analysis component 213. Conversely, data selection component 214 of the present invention can include data that has been determined useful (i.e., high degree of confidence level) to train the AI system. A confidence level threshold is established, either manually by the user or automatically by the system. Once, a confidence level threshold has been established, all training data must meet or exceed the threshold to be included in training an AI system. If the training data (from the simulations) does not meet the confidence level threshold then it is rejected/excluded from being used. For example, a confidence level threshold of 95% has been set. User2 has offered to train the same AI system. As the system compares user2′s reactions in the game simulation against his historical reactions in real life, the system has determined a confidence level of 40% (i.e., user2 is much more aggressive driving in the game than in real life). Thus, his reactions are rejected from being used for the training of the AI system.

It is noted that simulation data with low confidence level is to be discarded. The reason for the rejection is because there is potential for the system to be trained in any scenario that data being captured is/can be compromised (i.e., because the individual's tendencies being reviewed is not acting consistent with physical world activities).

In another example, user3 is helping train new improvements to safety equipment being offered to help crane operators. As shown, his data is consistent (i.e., confidence level of 96%) with his daily activities, the system has the ability to train emergency scenarios where sufficient real data is not available.

In yet another example, user4 is helping train an AI interface to ask questions about cargo loading safety. While user4 has a very high accident rate in the simulation environment, his accident rate for given tasks is consistent with his traditional accident rate in the physical world (i.e., confidence level of 98%). Thus, user4's simulation is of great value because he is an outlier to most individuals.

In yet another example, user5, is helping train a new AI system for autonomous vehicles. The system captures his historical driving habits and compares them to the simulator. Quality control scenarios in the built video game show that user5 is responding to stimuli in the same manner that he does in real life (i.e., confidence level of 100%). Thus, this allows the system to select data of user5 to pass the game simulation into the feed for the AI system.

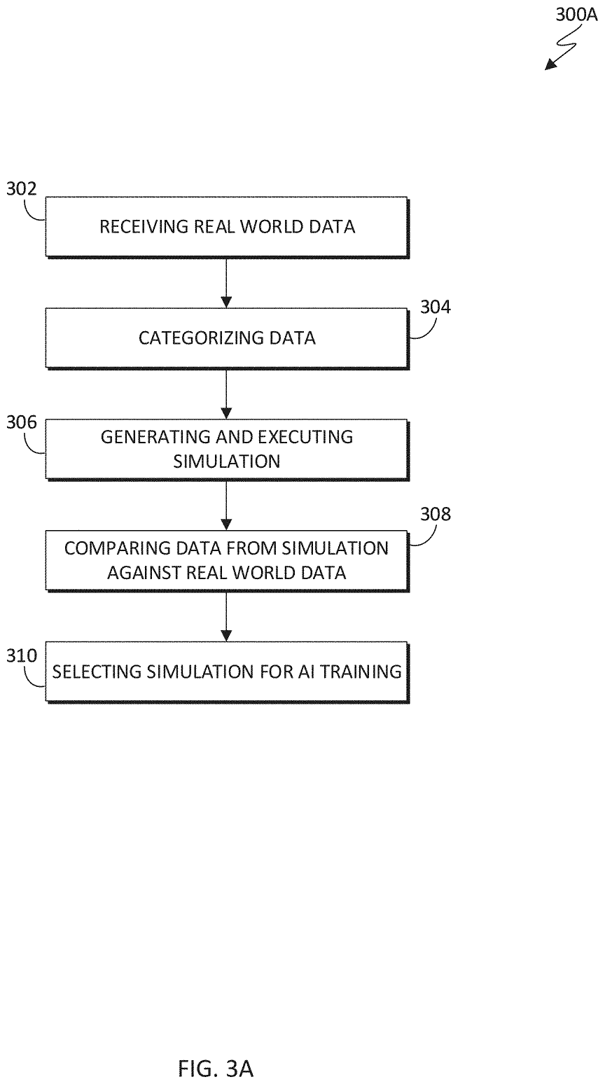

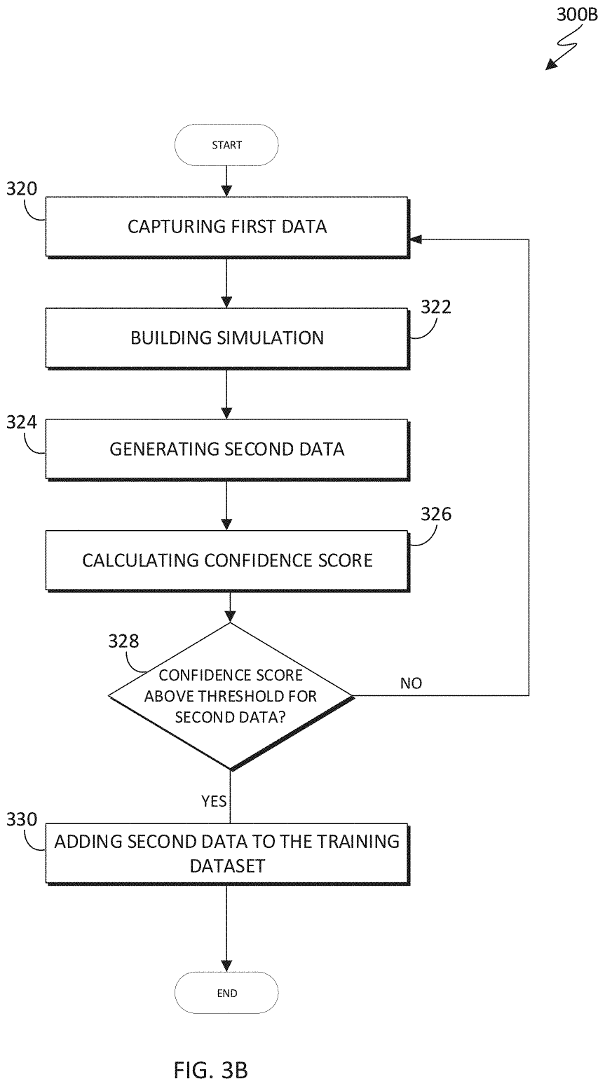

FIG. 3A is a flowchart illustrating the operation of AI training component 111, designated as 300B, in accordance with one embodiment of the present invention.

AI training component 111 receives data (step 302). In an embodiment, AI training component 111, through sensors component 211, receives collected data from a user. For example, user1 is driving a vehicle as part of his normal routine (e.g., driving to work, drive to the gym and drive to the grocery store, etc.). Sensors component 211 via sensors 103 (e.g., OBDII interface collect vehicle telemetry data, biometric sensor on a smartwatch and IoT camera captures surrounding car environment such as, traffic, pedestrians, etc.) located around the user1 can capture his driving habit.

AI training component 111 categorizes data (step 304). In an embodiment, AI training component 111, through simulation component 212, filters (i.e., classifies) through the collected data. Once, the data has been classified, a desired scenario can be selected to be generated as a simulation. For example, most of user1's real world driving involves city driving then the desired simulation to be generated is a city driving scenario.

AI training component 111 generates and executes simulation (step 306). In an embodiment, AI training component 111, through simulation component 212 generates a desired simulation. For example, referring to the previous example, simulation component 212 generates a simulation for user1. The user1 is asked to perform the driving simulation based on the scenario and completes the simulation.

AI training component 111 compares data (step 308). In an embodiment, AI training component 111, through data analysis component 213, compares the simulation data against the collected data. Based on the comparison, data analysis component 213 calculates a confidence level of the simulation data for that user. For example, referring to the previous example, data analysis component 213 calculates a confidence level of 95% for user1 (i.e., his real world driving versus his driving simulator score/data).

AI training component 111 selects data (step 310). In an embodiment, AI training component 111, through data selection component 214, determines if the simulation data meets a confidence level threshold. For example, referring to the previous example, a confidence level threshold was set to 90% by a trainer. The confidence level of user1 is 95%, thus, data selection component 214 can select his current collected data to be used to train an AI driving system. Furthermore, his subsequent simulation data (i.e., future time spent on various driving scenarios simulation) can be readily selected without addition data comparison since he has already established a pattern of consistency with his confidence level.

FIG. 3B is a flowchart illustrating an alternative operation of AI training component 111, designated as 300B, in accordance with another embodiment of the present invention.

AI training component 111 captures data (step 320), through sensors component 211 captures data (i.e., real world activities) of a user. For example, user2 is performing her job in a factory as assembling widgets (i.e., there are eight steps involves with her role) and her activities are being captured by AI training component 111.

AI training component 111 builds a simulation (step 322) based on the real world activity of the user. An AI trainer selects a specific scenario related to the activity to build a simulation. For example, an AI trainer determines that the last assembly step (step 8) of widget XYZ is important. AI training component 111, through simulation component 212, build the simulation for user2.

AI training component 111 generates simulation data (step 324) based on the completion of the simulation by the user. For example, AI trainer has already determined a scenario to build a simulation and uploads all the necessary the data to simulation 104. AI trainer asks user2 to complete the simulation. Simulation data is generated as soon as user2 has completed the simulation.

AI training component 111 calculates confidence score (step 326) based on the captured data versus the simulation data. For example, after user2 has completed the simulation (i.e., scenario mirrors step 8 of her role in assembling widget XYZ), AI training component 111, through data analysis component 213, determines a confidence score (i.e., 96%) for the simulation data of user2.

AI training component 111 determines if the confidence score is above a threshold (decision block 328). AI training component 111 determines if score of the simulation data meets or exceed the confidence level threshold. For example, the predetermined threshold (set by AI trainer) is set at “90%”. AI training component 111, through data analysis component 213, compares the simulation data score (i.e., 96%) against the threshold and concludes that the simulation data is above the threshold (i.e., 90%).

AI training component 111 including data in a training dataset (step 330). AI training component 111, through data selection component 214, selects the simulation data to be used as part of the training dataset.

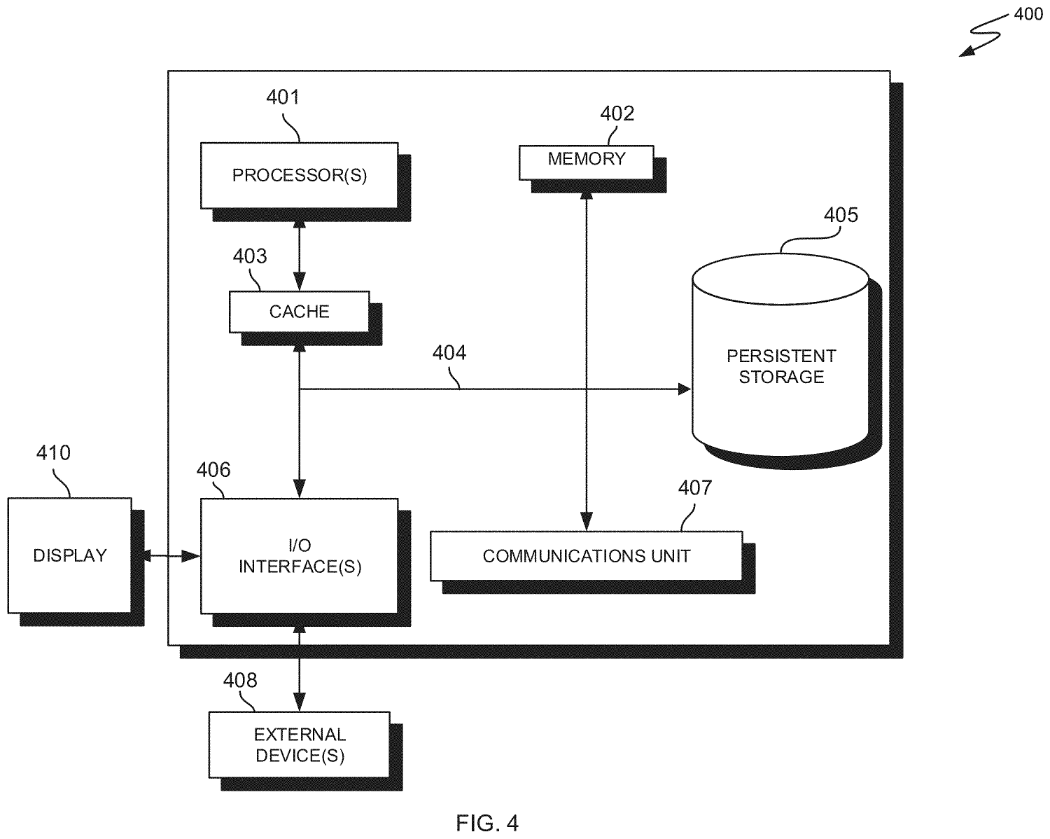

FIG. 4, designated as 400, depicts a block diagram of components of AI training component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data x10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. AI training component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., AI training component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., AI training component 111) used to practice embodiments of the present invention can be stored on such portable computer readable storage media and can be loaded onto persistent storage 405 via I/O interface(s) 406. I/O interface(s) 406 also connect to display 410.

Display 410 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. I t will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for selecting training data to add to a training dataset for a machine learning system, the computer-method comprising:
capturing a first data associated with a user activity;
building a simulation of a portion of the user activity based on the first data;
generating a second data based on executing the simulation;
calculating a confidence score based on a comparison of the first data against the second data;
determining if the confidence score is above a predetermined confidence threshold; and
responsive to determining that the confidence score is above the confidence threshold, adding the second data to a machine learning system training dataset.

2. The computer-implemented method of claim 1, wherein capturing the first data associated with the user activity, further comprises of collecting the first data via sensors.

3. The computer-implemented method of claim 1, wherein the user activity, further comprises of, but it is not limited to, driving a car, operating machinery, performing daily tasks at work and/or home and performing recreational activities.

4. The computer-implemented method of claim 1, wherein building the simulation of a portion of the user activity based on the first data, further comprises:
defining a scenario by an AI trainer; and
generating a simulation based on the defined scenario.

5. The computer-implemented method of claim 1, wherein generating the second data based on executing the simulation, further comprises completing the simulation by the user.

6. The computer-implemented method of claim 1, wherein calculating a confidence score based on the comparison of the first data against the second data, further comprises:
assigning a confidence score by leveraging data analysis technique between the first data and the second data.

7. The computer-implemented method of claim 1, wherein determining if the confidence score is above the predetermined confidence threshold, further comprises:
comparing the confidence score of the simulation against the predetermined confidence threshold.

8. The computer-implemented method of claim 1, wherein adding the second data to the machine learning system training dataset, further comprises:
including the simulation data to be used in the machine learning system training dataset.

9. The computer-implemented method of claim 1, further comprising:
excluding the simulation data with the confidence score below the predetermined confidence threshold.

10. A computer program product for selecting training data to add to a training dataset for a machine learning system, the computer program product comprising:
one or more computer readable storage media and program instructions stored on the one or more computer readable storage media, the program instructions comprising:
program instructions to capture a first data associated with a user activity;
program instructions to build a simulation of a portion of the user activity based on the first data;
program instructions to generate a second data based on executing the simulation;
program instructions to calculate a confidence score based on a comparison of the first data against the second data;
program instructions to determine if the confidence score is above a predetermined confidence threshold; and
responsive to determining that the confidence score is above the confidence threshold, program instructions to add the second data to a machine learning system training dataset.

11. The computer program product of claim 10, wherein the user activity, further comprises of, but it is not limited to, driving a car, operating machinery, performing daily tasks at work and/or home and performing recreational activities.

12. The computer program product of claim 10, wherein program instructions to build the simulation of a portion of the user activity based on the first data, further comprises:
program instructions to define a scenario by an AI trainer; and
program instructions to generate a simulation based on the defined scenario.

13. The computer program product of claim 10, wherein calculating a confidence score based on the comparison of the first data against the second data, further comprises:
program instructions to assign a confidence score by leveraging data analysis technique between the first data and the second data.

14. The computer program product of claim 10, wherein determining if the confidence score is above the predetermined confidence threshold, further comprises:
program instructions to compare the confidence score of the simulation against the predetermined confidence threshold.

15. The computer program product of claim 10, wherein adding the second data to the machine learning system training dataset, further comprises:
program instructions to include the simulation data to be used in the machine learning system training dataset.

16. A computer system for selecting training data to add to a training dataset for a machine learning system, the computer system comprising:
one or more computer processors;
one or more computer readable storage media;
program instructions stored on the one or more computer readable storage media for execution by at least one of the one or more computer processors, the program instructions comprising:
program instructions to capture a first data associated with a user activity;
program instructions to build a simulation of a portion of the user activity based on the first data;
program instructions to generate a second data based on executing the simulation;
program instructions to calculate a confidence score based on a comparison of the first data against the second data;
program instructions to determine if the confidence score is above a predetermined confidence threshold; and
responsive to determining that the confidence score is above the confidence threshold, program instructions to add the second data to a machine learning system training dataset.

17. The computer system of claim 16, wherein the user activity, further comprises of, but it is not limited to, driving a car, operating machinery, performing daily tasks at work and/or home and performing recreational activities.

18. The computer system of claim 16, wherein program instructions to build the simulation of a portion of the user activity based on the first data, further comprises:
program instructions to define a scenario by an AI trainer; and
program instructions to generate a simulation based on the defined scenario.

19. The computer system of claim 16, wherein calculating a confidence score based on the comparison of the first data against the second data, further comprises:
program instructions to assign a confidence score by leveraging data analysis technique between the first data and the second data.

20. The computer system of claim 16, wherein adding the second data to the machine learning system training dataset, further comprises:
program instructions to include the simulation data to be used in the machine learning system training dataset.
